(19) United States
(12) Patent Application Publication
(10) Pub. No.: US 2019/0012969 A1
(43) Pub. Date: Jan. 10, 2019

(54) SOURCE DRIVE CIRCUIT, AND LIQUID CRYSTAL DISPLAY PANEL AND METHOD OF DRIVING THE SAME

(71) Applicants: Shenzhen China Star Optoelectronics Technology Co. Ltd., Shenzhen (CN); Wuhan China Star Optoelectronics Technology Co. Ltd., Wuhan (CN)

(72) Inventor: Feilin JI, Shenzhen (CN)

(73) Assignees: Shenzhen China Star Optoelectronics Technology Co. Ltd., Shenzhen (CN); Wuhan China Star Optoelectronics Technology Co. Ltd., Wuhan (CN)

(21) Appl. No.: 14/897,713

(22) PCT Filed: Oct. 19, 2015
(86) PCT No.: PCT/CN2015/092183

§ 371 Date: Feb. 12, 2018

(30) Foreign Application Priority Data
Sep. 8, 2015 (CN) 201510566431.9

(51) Int. Cl. G09G 3/36; G06F 3/041; G02F 1/1333; G02F 1/133

(52) U.S. Cl. CPC G09G 3/36; G06F 3/0412; G06F 3/0416; G09G 2310/0291; G02F 1/13306; G09G 2300/0408; G02F 1/13338

(57) ABSTRACT

A source drive circuit, a liquid crystal display panel and a method for driving the same are disclosed. The source drive circuit comprises a data temporary storage module used for generating a first driving signal based on a digital image signal; a digital to analog converting module used for performing digital to analog conversion on the first driving signal so as to obtain a first analog image signal; a buffering and amplifying module used for amplifying the first analog image signal so as to obtain a second analog image signal; and a screen cleaning module used for pulling down a signal output by the buffering and amplifying module according to a source selection signal, so that charge coupled with liquid crystal is released. In the source drive circuit, charge coupled with liquid crystal of the In-cell liquid crystal display panel when the panel is in a standby state due to touch detection scanning thereof can be effectively cleaned, and the case that the liquid crystal is polarized since it has a same polarity for a long time can be avoided.

### CROSS REFERENCE TO RELATED APPLICATION

The present application claims priority of Chinese patent application CN201510566431.9, entitled “Source Drive Circuit, and Liquid Crystal Display Panel and Method of Driving the Same” and filed on Sep. 8, 2015, the entirety of which is incorporated herein by reference.

### FIELD OF THE INVENTION

The present disclosure relates to the technical field of liquid crystal display, and particularly to a source drive circuit, a liquid crystal display panel and a method of driving the same.

### BACKGROUND OF THE INVENTION

With continuous development of liquid crystal display technology, lightening, thinning, and intellectualization have become future development trend of small and medium sized mobile phone panel. In order to meet the requirement of consumers or attract interest of consumers, mobile phone manufacturers have been introducing new functions, and touch function have made substantial development with the development of intelligent mobile phone.

The structural relationship between a touch screen and a liquid crystal display screen has experienced many development stages. That is, in a One Glass Solution (OGS) screen at early stage, the touch screen and the liquid crystal display screen are separated from each other; in an On-cell screen at later stage, the touch screen is formed on a color filter of the liquid crystal display screen; and in an In-cell screen at present, the Transmitter/Receiver (TX/RX) of the touch screen is arranged at two sides or one side of an array substrate and a color filter of the liquid crystal display screen. The In-cell screen with a small thickness becomes a development trend in the future.

However, as shown in FIG. 1, in a liquid crystal display device with a full In-cell structure, a touch sensor is generally arranged at one side of the array substrate. With respect to this kind of liquid crystal display device, as shown in FIG. 2, time-sharing multiplexing driving method is generally used. That is, the touch sensor serves as a common electrode during normal image display stage, while serves as a TX end or a RX end during touch detection scanning stage.

With the intellectualized development of mobile phone, there is an increasingly high requirement for touch technology. The mobile phone manufacturers have introduced many new touch functions, among which gesture wake-up has become a selling point of intelligent mobile phone. The gesture wake-up can be double-click wake-up, or the mobile phone can be woken up by a specific gesture and then enters into a specific application software and turns on a specific function. Therefore, with respect to this kind of liquid crystal display panel, the touch detection scanning should be continuously performed when the panel is in a standby state so as to determine whether there is a gesture performed by a user to wake up the mobile phone.

With respect to the full In-cell liquid crystal display panel, since touch detection should be performed by the touch sensor when the panel is in the standby state, a square wave or a sine wave should be continuously input into the touch sensor. The type and time-sequence of the signal that is input into the touch sensor change according to different detection scanning driving methods. In the standby time-sequence diagram as shown in FIG. 3, a square wave is input to the touch sensor in the touch scanning period of each frame.

As shown in FIG. 4, since the touch sensor serves as the common electrode when the panel is in the standby state, charges can be coupled with a source (i.e., V_{A} and V_{B}) of a Thin Film Transistor (TFT) through an energy storage capacitor. As a result, voltage with a same polarity would be coupled with the source of the TFT no matter a square wave or a sine wave is input to the touch sensor. If the liquid crystal display panel is in the standby state for a long period of time, the liquid crystal therein would be polarized since it has a same polarity for a long time, and an abnormal image display would be generated.

### SUMMARY OF THE INVENTION

The present disclosure aims to prevent the liquid crystal from being polarized when a full In-cell liquid crystal display panel is in a standby state for a long time. In order to solve the aforesaid technical problem, the present disclosure provides a source drive circuit, which comprises a plurality of output channels, wherein each output channel comprises:

a data temporary storage module, used for generating a first driving signal based on a digital image signal received therein;

a digital to analog converting module, connected with the data temporary storage module and used for performing digital to analog conversion on the first driving signal so as to obtain a first analog image signal;

a buffering and amplifying module, connected with the digital to analog converting module and used for amplifying the first analog image signal so as to obtain a second analog image signal; and

a screen cleaning module, connected with the buffering and amplifying module and used for pulling down a signal output by the buffering and amplifying module according to a source selection signal, so that charge coupled with liquid crystal is released.

According to one embodiment of the present disclosure, the screen cleaning module comprises a switching unit, a first external port and a second external port of the switching unit are respectively connected with an output end of the buffering and amplifying module and a ground wire, and a control port of the switching unit is connected with a signal selection line which is used for transmitting the source selection signal.

According to one embodiment of the present disclosure, control ports of the switching units of each of the output channels are connected with one signal selection line.

According to one embodiment of the present disclosure, the switching unit comprises a field effect transistor, a source and a drain of the field effect transistor respectively form the first external port and the second external port of the switching unit, and a gate of the field effect transistor forms the control port of the switching unit.

According to one embodiment of the present disclosure, the data temporary storage module comprises a first data temporary storage unit and a second data temporary storage unit, and the second data temporary storage unit is connected between the first data temporary storage unit and the digital to analog converting module.

According to one embodiment of the present disclosure, the source drive circuit further comprises a source selection signal generation module, which is connected with the screen cleaning module and enables the screen cleaning module to pull down the signal output by the buffering and amplifying module through the source selection signal generated therein.

According to one embodiment of the present disclosure, each output channel further comprises a level converting module, which is connected between the data temporary storage module and the digital to analog converting module and used for converting a level of the first driving signal.

The present disclosure further provides a method for driving a liquid crystal display panel, wherein the method is performed by any one of the aforesaid source drive circuit. The method comprises:

enabling, during a first display period, the source selection signal to be in a first level so as to enable the screen cleaning module to maintain an output end of the buffering and amplifying module in a high impedance state, and at the same time, enabling a Gate On Array (GOA) circuit to output a low-level signal; and

enabling, during a second display period, the source selection signal to be in a second level so as to enable the screen cleaning module to pull down the signal output by the buffering and amplifying module, and at the same time, enabling the GOA circuit to output a scanning signal.

According to one embodiment of the present disclosure, the first display period comprises n adjacent frames and a touch scanning period of n+1 frame, and the second display period comprises a standby period of n+1 frame.

The present disclosure further provides a liquid crystal display panel, which comprises any one of the aforesaid source drive circuit.

In the liquid crystal display panel according to the present disclosure, the output end of the source drive circuit is connected with the ground wire in a certain time period, and the GOA circuit outputs a scanning signal for at least one scanning cycle. In this manner, charge coupled with liquid crystal of the In-cell liquid crystal display panel when the panel is in a standby state due to touch detection scanning thereof can be effectively cleaned, and the case that the liquid crystal is polarized since it has a same polarity for a long time can be avoided. Moreover, compared with traditional source drive circuit, the source drive circuit disclosed herein has a lower power consumption.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The drawings necessary for explaining the embodiments or the prior art are introduced briefly below to illustrate the technical solutions of the embodiments of the present disclosure or the prior art more clearly.

FIG. 1 schematically shows a structure of a traditional liquid crystal display panel;

FIG. 2 is an operating time-sequence diagram of the traditional liquid crystal display panel;

FIG. 3 is a standby time-sequence diagram of the traditional liquid crystal display panel;

FIG. 4 schematically shows part of circuit of the traditional liquid crystal display panel;

FIG. 5 schematically shows a structure of one output channel of a source drive circuit according to one embodiment of the present disclosure; and

FIG. 6 is a standby time-sequence diagram of a liquid crystal display panel according to one embodiment of the present disclosure.

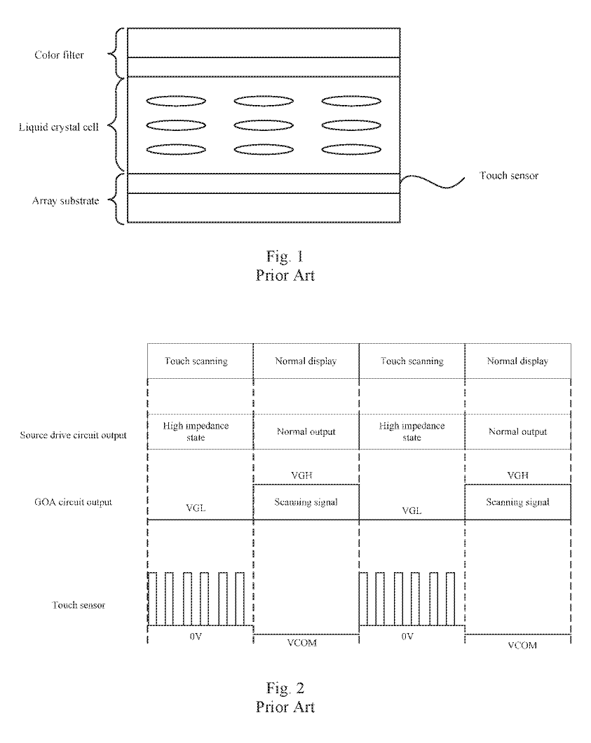

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

Many specific details are illustrated hereinafter for providing a thorough understanding of the embodiments of the present disclosure. However, it is obvious for those skilled in the art that, the present disclosure can be implemented in other methods in addition to the details or specifics described herein.

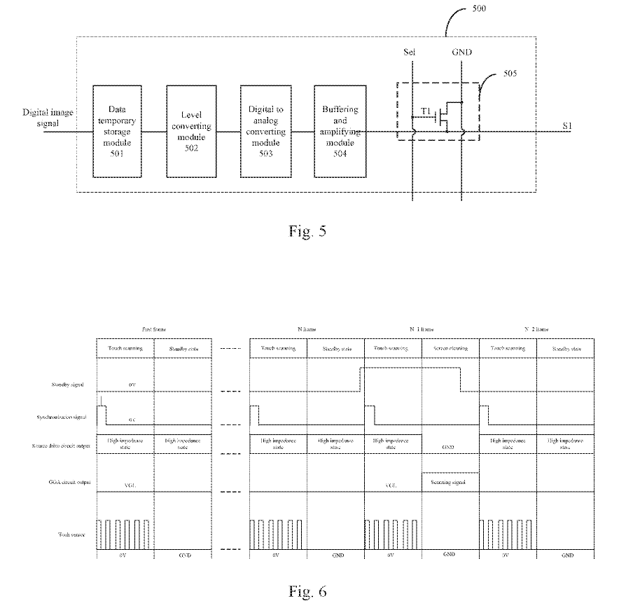

With respect to the technical problem that the liquid crystal is polarized since it has a same polarity for a long time when the traditional full In-cell liquid crystal display panel is in a standby state, the embodiment provides a new source drive circuit used in the liquid crystal display panel. The source drive circuit comprises a plurality of output channels with a same structure, and FIG. 5 schematically shows a structure of a first output channel 500 of the source drive circuit.

As shown in FIG. 5, the first output channel 500 is connected with a data line S1. The first output channel 500 comprises a data temporary storage module 501, a level converting module 502, a digital to analog converting module 503, a buffering and amplifying module 504, and a screen cleaning module 505. The data temporary storage module 501 can store a data which is output to a sub pixel corresponding to a scanning line.

According to the present embodiment, the data temporary storage module 501 preferably comprises two data temporary storage units, i.e., a first data temporary storage unit and a second data temporary storage unit. The second data temporary storage unit is connected between the first data temporary storage unit and the level converting module 502. In this manner, when a sub pixel connected with a scanning line in n−1 row is charged by a data stored in the second data temporary storage unit, a data corresponding to a sub pixel in a scanning line in n row can be stored in the first data temporary storage unit.

If the data temporary storage module comprises only one data temporary storage unit (for example, the first data temporary storage unit), the data corresponding to the sub pixel connected with the scanning line in n row can only be stored in the data temporary storage unit after the sub pixel connected with the scanning line in n−1 row is charged. Compared with the structure comprising two data temporary storage units according to the present embodiment, the traditional source drive circuit which comprises only one data temporary storage unit is time-consuming.

In different types of liquid crystal display panel, the source drive circuit comprises different numbers of data temporary storage units. For example, in a 6 bit liquid crystal display screen with high definition, the source drive circuit comprises 69120 data temporary storage units.

In the digital to analog converting module 503, a corresponding transistor should be turned on when gamma voltage is selected. A highest level of a first driving signal output by the data temporary storage module 501 is 3.3 V, the level of the first driving signal should be converted by the level converting module 502 so as to obtain a signal with a higher level (i.e., a second driving signal).

It should be noted that, according to other embodiments of the present disclosure, when the level of the first driving signal output by the data temporary storage module 501 is high enough to meet the requirement of the digital to analog converting module 503, the source drive circuit is not necessarily provided with the level converting module 502. The present disclosure is not limited by this.

The digital to analog converting module 503 is connected with the level converting module 502. The digital to analog converting module 503 is used for performing digital to analog conversion on the second driving signal output by the level converting module 502 so as to obtain a corresponding first analog image signal. In this manner, the digital to analog converting module 503 can obtain different voltages used for driving the liquid crystal to display with different gray-scale values based on different second driving signals.

Since the level of the first analog image signal output by the digital to analog converting module 503 is generated through resistor voltage dividing, a ratio of the resistors decides the level of the first analog image signal. With this structure, when outside environment or chip manufacturing procedure changes, the level of the first analog image signal output by the digital to analog converting module 503 does not change.

An absolute value of a voltage dividing resistor would affect power consumption and driving ability thereof. The larger the resistance of the voltage dividing resistor is, the less the power consumption of the voltage dividing resistor would become. However, at this time, the voltage dividing resistor would easily be affected by the load, and thus the level of the first analog image signal would change. Therefore, in order to reduce the power consumption, the voltage dividing resistor should have a larger resistance, and the load of the first analog image signal should be reduced. Hence, according to the present embodiment, the source drive circuit is provided with a buffering and amplifying module 504 so as to amplify the first analog image signal and obtain a second analog image signal, whereby the driving ability of the analog image signal can be improved.

Specifically, according to the present embodiment, the buffering and amplifying module 504 is preferably realized by a follower circuit which is composed of an operational amplifier. Of course, according to other embodiments of the present disclosure, the buffering and amplifying module 504 can also be realized by other reasonable components and circuit, and the present disclosure is not limited by this.

As shown in FIG. 5, the screen cleaning module 505 is connected with the buffering and amplifying module 504. Specifically, according to the present embodiment, the screen cleaning module 505 comprises a switching unit T1, a first external port and a second external port of the switching unit T1 are respectively connected with an output end of the buffering and amplifying module 504 and a ground wire, and a control port of the switching unit T1 is connected with a signal selection line which is used for transmitting the source selection signal Sel. The screen cleaning module 505 can pull down a signal output by the buffering and amplifying module 504 under control of the source selection signal, so that charge coupled with liquid crystal can be released.

According to the present embodiment, the switching unit T1 is a field effect transistor. A source and a drain of the field effect transistor respectively form the first external port and the second external port of the switching unit T1, and a gate of the field effect transistor forms the control port of the switching unit T1.

It should be noted that, according to other embodiments of the present disclosure, the switching unit T1 can also be realized by other reasonable components and circuit, and the present disclosure is not limited by this.

According to the present embodiment, the source selection signal which is used for controlling the screen cleaning module 505 is generated by a source selection signal generation module. It should be noted that, according to different embodiments of the present disclosure, the source selection signal generation module can be integrated in the source drive circuit, or can be acted by other circuits in the liquid crystal display panel, and the present disclosure is not limited by this.

When the liquid crystal display panel is in a standby state, during a first display period, the source selection signal generation module generates the source selection signal in a first level, and an output end of the buffering and amplifying module 504 is in a high impedance state. At this time, a GOA circuit which is used for generating a scanning signal outputs a low-level signal.

During a second display period, the source selection signal generation module generates the source selection signal in a second level so as to enable the screen cleaning module 505 to pull down the signal output by the buffering and amplifying module 504. At the same time, the GOA circuit outputs a scanning signal to the scanning lines row by row. In this manner, the charge coupled with liquid crystal can be released, and the case that the liquid crystal is polarized can be avoided.

FIG. 6 is a standby time-sequence diagram of the liquid crystal display panel according to the present embodiment.

As shown in FIG. 6, according to the present embodiment, during a first frame to n frame, a standby signal output by AP (Wireless Access Point) plate is in a low-level. During this time period, the GOA circuit continuously outputs a low-level signal. At the same time, during a touch scanning period of each frame, a touch scanning signal is continuously input to a touch sensor so as to detect whether the liquid crystal display panel is touched. During the standby period of each frame, a common electrode signal is continuously input to the touch sensor so that the touch sensor serves as a common electrode. In this manner, the time-sharing multiplexing function of the touch sensor can be realized. Meanwhile, during this period, the source drive circuit does not output signal and is in a high impedance state.

During n+1 frame, a standby signal output by AP plate is in a low-level. During the touch scanning period of n+1 frame, the touch scanning signal is continuously input to the touch sensor so as to detect whether the liquid crystal display panel is touched. During the touch scanning period, the source drive circuit does not output signal and is in a high impedance state. During a standby period of n+1 frame, the GOA circuit outputs a scanning signal to the scanning lines row by row, and at the same time, the source selection signal generation module generates a high-level source selection signal. The screen cleaning module 505, after receiving the high-level source selection signal, connects the output end of the buffering and amplifying module 504 and the ground wire so as to pull down the signal output by the buffering and amplifying module 504. According to the present embodiment, the standby period of n+1 frame can also be called as a screen cleaning period.

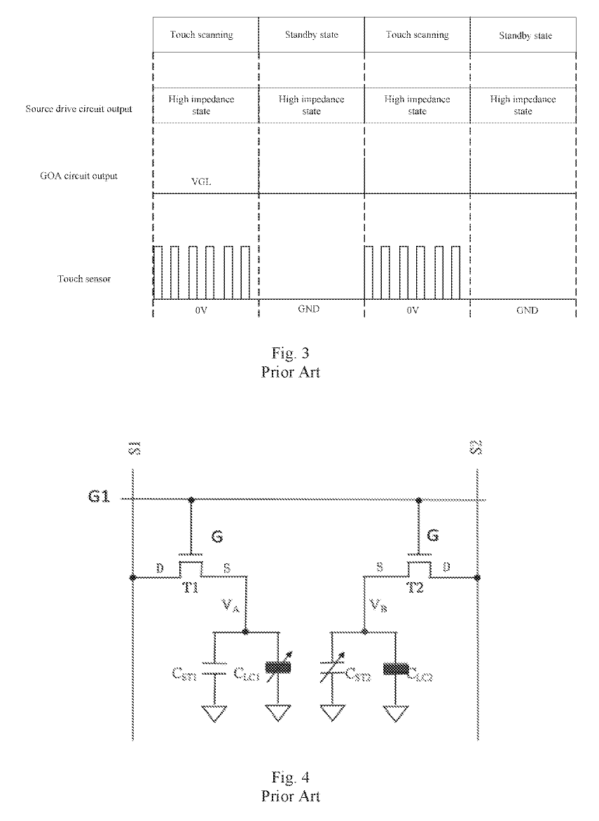

According to the present embodiment, the screen cleaning modules in each output channel act in the same way. The screen cleaning modules are connected with one signal selection line Sel. Therefore, during the standby period of n+1 frame, the output ends of the buffering and amplifying modules 504 of each output channel are all connected with the ground wire. Since at this time, the TFT switches connected with each scanning line are turned on in sequence, V_{A} and V_{B} as shown in FIG. 3 are connected with the ground. In this manner, the charge coupled to V_{A} and V_{B} due to touch detection scanning can be released, and the case that the liquid crystal is polarized since it has a same polarity for a long time can be avoided.

In n+2 frame, the modules in the liquid crystal display panel all work in the same way as in the first frame to n frame, and the details of which are no longer repeated here.

It should be noted that, according to different embodiments of the present disclosure, the aforesaid n can be arranged as different reasonable values by the AP plate taking the power consumption when the panel is in the standby state and the planned risk into consideration. The present disclosure is not limited by this.

It can be seen from the above description that, in the liquid crystal display panel according to the present embodiment, the output end of the source drive circuit is connected with the ground wire in a certain time period, and the GOA circuit outputs a scanning signal for at least one scanning cycle. In this manner, charge coupled with liquid crystal of the In-cell liquid crystal display panel when the panel is in a standby state due to touch detection scanning thereof can be effectively cleaned, and the case that the liquid crystal is polarized since it has a same polarity for a long time can be avoided. Moreover, compared with traditional source drive circuit, the source drive circuit disclosed herein has a lower power consumption.

It could be understood that, the embodiments disclosed herein are not limited by the specific structures or treatment steps disclosed herein, but incorporate the equivalent substitutes of these features which are comprehensible to those skilled in the art. It could be also understood that, the terms used herein are used for describing the specific embodiments, not for limiting them.

The phrases “one embodiment” or “embodiments” referred to herein mean that the descriptions of specific features, structures and characteristics in combination with the embodiments are included in at least one embodiment of the present disclosure. Therefore, the phrases “one embodiment” or “embodiments” appeared in different parts of the whole description do not necessarily refer to the same embodiment.

For the purpose of convenience, a plurality of items and/or component units used herein can be listed in a common list. However, the list shall be understood in a way that each element thereof represents an only and unique member. Therefore, when there is no other explanation, none of members of the list can be understood as an actual equivalent of other members in the same list only based on the fact that they appear in the same list. In addition, the embodiments and examples of the present disclosure can be explained with reference to the substitutes of each of the components. It could be understood that, the embodiments, examples and substitutes herein shall not be interpreted as the equivalents of one another, but shall be considered as separate and independent representatives of the present disclosure.

The embodiments are described hereinabove to interpret the principles of the present disclosure in one application or a plurality of applications. However, a person skilled in the art, without departing from the principles and thoughts of the present disclosure, can make various modifications to the forms, usages and details of the embodiments of the present disclosure without any creative work. Therefore, the protection scope of the present disclosure shall be determined by the claims.

1. A source drive circuit, comprising a plurality of output channels, wherein each output channel comprises:
a data temporary storage module, used for generating a first driving signal based on a digital image signal received therein;
a digital to analog converting module, connected with the data temporary storage module and used for performing digital to analog conversion on the first driving signal so as to obtain a first analog image signal;
a buffering and amplifying module, connected with the digital to analog converting module and used for amplifying the first analog image signal so as to obtain a second analog image signal; and
a screen cleaning module, connected with the buffering and amplifying module and used for pulling down a signal output by the buffering and amplifying module according to a source selection signal, so that charge coupled with liquid crystal is released.

2. The source drive circuit according to claim 1, wherein the screen cleaning module comprises a switching unit, a first external port and a second external port of the switching unit are respectively connected with an output end of the buffering and amplifying module and a ground wire, and a control port of the switching unit is connected with a signal selection line which is used for transmitting the source selection signal.

3. The source drive circuit according to claim 2, wherein control ports of the switching units of each of the output channels are connected with one signal selection line.

4. The source drive circuit according to claim 2, wherein the switching unit comprises a field effect transistor, a source and a drain of the field effect transistor respectively form the first external port and the second external port of the switching unit, and a gate of the field effect transistor forms the control port of the switching unit.

5. The source drive circuit according to claim 1, wherein the data temporary storage module comprises a first data temporary storage unit and a second data temporary storage unit, and the second data temporary storage unit is connected between the first data temporary storage unit and the digital to analog converting module.

6. The source drive circuit according to claim 1, wherein the source drive circuit further comprises a source selection signal generation module, which is connected with the screen cleaning module and enables the screen cleaning module to pull down the signal output by the buffering and amplifying module through the source selection signal generated therein.

7. The source drive circuit according to claim 1, wherein each output channel further comprises a level converting module, which is connected between the data temporary storage module and the digital to analog converting module and used for converting a level of the first driving signal.

8. A liquid crystal display panel, comprising a source drive circuit, which comprises:
a data temporary storage module, used for generating a first driving signal based on a digital image signal received therein;
a digital to analog converting module, connected with the data temporary storage module and used for performing digital to analog conversion on the first driving signal so as to obtain a first analog image signal;
a buffering and amplifying module, connected with the digital to analog converting module and used for amplifying the first analog image signal so as to obtain a second analog image signal; and
a screen cleaning module, connected with the buffering and amplifying module and used for pulling down a signal output by the buffering and amplifying module according to a source selection signal, so that charge coupled with liquid crystal is released.

9. The liquid crystal display panel according to claim 8, wherein the screen cleaning module comprises a switching unit, a first external port and a second external port of the switching unit are respectively connected with an output end of the buffering and amplifying module and a ground wire, and a control port of the switching unit is connected with a signal selection line which is used for transmitting the source selection signal.

10. The liquid crystal display panel according to claim 9, wherein control ports of the switching units of each of the output channels are connected with one signal selection line.

11. The liquid crystal display panel according to claim 9, wherein the switching unit comprises a field effect transistor, a source and a drain of the field effect transistor respectively form the first external port and the second external port of the switching unit, and a gate of the field effect transistor forms the control port of the switching unit.

12. The liquid crystal display panel according to claim 8, wherein the data temporary storage module comprises a first data temporary storage unit and a second data temporary storage unit, and the second data temporary storage unit is connected between the first data temporary storage unit and the digital to analog converting module.

13. The liquid crystal display panel according to claim 8, wherein the source drive circuit further comprises a source selection signal generation module, which is connected with the screen cleaning module and enables the screen cleaning module to pull down the signal output by the buffering and amplifying module through the source selection signal generated therein.

14. The liquid crystal display panel according to claim 8, wherein each output channel further comprises a level converting module, which is connected between the data temporary storage module and the digital to analog converting module and used for converting a level of the first driving signal.

15. A method for driving a liquid crystal display panel, wherein the method is performed by a preset source drive circuit;
wherein the preset source drive circuit comprises:
a data temporary storage module, used for generating a first driving signal based on a digital image signal received therein;
a digital to analog converting module, connected with the data temporary storage module and used for performing digital to analog conversion on the first driving signal so as to obtain a first analog image signal;
a buffering and amplifying module, connected with the digital to analog converting module and used for amplifying the first analog image signal so as to obtain a second analog image signal; and
a screen cleaning module, connected with the buffering and amplifying module and used for pulling down a signal output by the buffering and amplifying module according to a source selection signal, so that charge coupled with liquid crystal is released; and
wherein the method comprises:
enabling, during a first display period, the source selection signal to be in a first level so as to enable the screen cleaning module to maintain an output end of the buffering and amplifying module in a high impedance state, and at the same time, enabling a GOA circuit to output a low-level signal; and
enabling, during a second display period, the source selection signal to be in a second level so as to enable the screen cleaning module to pull down the signal output by the buffering and amplifying module, and at the same time, enabling the GOA circuit to output a scanning signal.

16. The method according to claim 15, wherein the first display period comprises n adjacent frames and a touch scanning period of n+1 frame, and the second display period comprises a standby period of n+1 frame.

17. The method according to claim 15, wherein the screen cleaning module comprises a switching unit, a first external port and a second external port of the switching unit are respectively connected with an output end of the buffering and amplifying module and a ground wire, and a control port of the switching unit is connected with a signal selection line which is used for transmitting the source selection signal.

18. The method according to claim 17, wherein control ports of the switching units of each of the output channels are connected with one signal selection line.

19. The method according to claim 15, wherein the data temporary storage module comprises a first data temporary storage unit and a second data temporary storage unit, and the second data temporary storage unit is connected between the first data temporary storage unit and the digital to analog converting module.

20. The method according to claim 15, wherein the source drive circuit further comprises a source selection signal generation module, which is connected with the screen cleaning module and enables the screen cleaning module to pull down the signal output by the buffering and amplifying module through the source selection signal generated therein.
